(19) United States
(12) Patent Application Publication
(10) Pub. No.: US 2025/0263212 A1
(43) Pub. Date: Aug. 21, 2025

(54) Container

(71) Applicant: AS Strömungstechnik GmbH, Ostfildern (DE)

(72) Inventors: Andreas Szeteli, Kleiststr. 23 (DE); Nico Fischer, Stuttgart (DE)

(21) Appl. No.: 19/053,506

(22) Filed: Feb. 14, 2025

(30) Foreign Application Priority Data
Feb. 19, 2024 (DE) 102024104627.9

(51) Int. Cl. B65D 51/24; B65D 39/00

(52) U.S. Cl. CPC B65D 51/24; B65D 39/00

(57) ABSTRACT

A container (2) for storing a liquid (3), with a container opening and with a closure means (12) designed for closing the container opening. The closure means (12) consists of electrically dissipative material and is designed for dissipating electrostatic charges of the liquid (3).

### CROSS REFERENCE TO RELATED APPLICATIONS

This application claims the priority of DE 102024104627.9 filed on 2024 Feb. 20; this application is incorporated by reference herein in its entirety.

### BACKGROUND

The invention relates to a container for storing liquid.

The container generally has a container opening via which liquid can be removed from the container and liquid can also be supplied to the container. The container opening can be closed off with a closure means. In particular for containers used in the semiconductor industry, the closure means generally consists of an electrically insulating material, e.g. a plastic. The container closed with the closure means then forms a transportable unit.

Highly flammable media, in particular, can be transported in such containers. There is thus an increased risk of explosion when the medium, i.e. the liquid, builds up an electrostatic charge in the container.

To counteract this risk, it is known to equip the wall of the container with an outer layer consisting of an electrically dissipative material and an inner layer consisting of electrically insulating material. An electrically conductive element is then brought into contact with the outer layer, wherein the element protrudes into the container and thus can come into contact with the liquid, such that charges of static electricity in the liquid can be dissipated.

Such an element can be formed by, e.g. an electrically conductive strip that hangs into the interior of the container.

Such elements are susceptible to mechanical impairments, i.e. they can be easily damaged, such that dissipation of static electricity charges of the liquid in the container is then no longer possible.

The container can also be a component of a dispensing system.

Such a dispensing system is used for filling and draining containers, particularly barrels, filled with liquid chemicals. The chemicals can be highly flammable. The dispensing system comprises a dispense head, which can be fastened to a dip tube of a container. By means of the dispense head, via the dip tube, liquid can be dispensed from the container or liquid can be supplied to the container. The dip tube is mounted as an installation part in a container opening of the container such that the dip tube projects into the interior of the container.

Containers of such dispensing systems also have a multilayer structure with an outer layer consisting of a dissipative material and an inner layer consisting of an electrically insulating material. The dip tube, which itself consists of dissipative material, is mounted in the container in an electrically insulated manner.

To prevent electrostatic charges of the liquid in the container, additional connection components must be fastened to the top of the dip tube, the connection components ensuring dissipation of electrostatic charges of the liquid in the container via the dip tube to the outer layer of the container, said outer layer consisting of dissipative material.

Such additional connection components cause significant additional design work. Moreover, the connection components can be damaged or torn off during a transport of the container.

### SUMMARY

The invention relates to a container (2) for storing a liquid (3), with a container opening and with a closure means (12) designed for closing the container opening. The closure means (12) consists of electrically dissipative material and is designed for dissipating electrostatic charges of the liquid (3).

### DETAILED DESCRIPTION

The invention seeks to solve the problem of providing a system with a simple design by means of which the risk of electrostatic charges of a liquid in a container can be reduced.

The features of claim 1 are provided to solve this problem. Advantageous embodiments of the invention and appropriate further developments are described in the dependent claims.

The invention relates to a container for storing a liquid, with a container opening and with a closure means designed for closing the container opening. The closure means consists of electrically dissipative material and is designed for dissipating electrostatic charges of the liquid.

Using the closure means according to experience, the risk of electrostatic charges of a liquid and a risk of explosion caused thereby can be efficiently reduced in a manner relying on a simple design.

For this purpose, the closure means according to the invention consists of electrically dissipative material, i.e. typically of a material with electrical conductivity that is at least low, such that it dissipates electrostatic charges.

Using the closure means according to the invention, electrostatic charges of the liquid in the container are avoided in particular when opening or closing the container.

Typically the closure means is designed such that it can be opened with a grounded tool.

Of course, the grounded tool can also be used for a corresponding closing process.

When the grounded tool comes into contact with the closure means according to the invention, electrostatic charges are dissipated via the closure means, whereby the risk of electrostatic charges of the liquid in the container can be reduced.

It is especially advantageous for the closure means to be a closure stopper.

The closure stopper can be fixed in the container opening with, for example, a screw, latch or clamp connection or similar.

Advantageously, the closure means consists of a plastic containing electrically conductive particles.

The plastic can be electrically insulating, since the electrical conductivity of the particles is sufficient to give the closure means the electrically dissipative property.

The conductive particles are soot or carbon particles, in particular.

Advantageously, the closure means according to the invention forms an additional element for preventing electrostatic charges of the liquid in the container, i.e. the closure means does not form the only safety element against electrostatic charges of the liquid.

Advantageously, the container has an outer layer consisting of electrically dissipative material and an inner layer consisting of electrically insulating material.

The container outer layer consisting of electrically conductive material forms an essential safety element for dissipating electrostatic charges.

Advantageously, an element consisting of electrically conductive or electrically dissipative material is present so that electrostatic charges of the liquid can be dissipated. This element is connected electrically conductively to the outer layer consisting of electrically dissipative material which protrudes into the container and can be brought into contact with the liquid.

The closure means is also connected electrically conductively to the outer layer.

Thus electrostatic charges can be dissipated via the closure means and the outer layer of the container when the closure means is actuated using a grounded tool.

Advantageously, the container can be a component of a dispensing system, which has at least one dispense head by means of which liquid can be supplied to a container or dispensed from it.

In this case in particular, the container has a dip tube consisting of an electrically dissipative material.

The dip tube protrudes into the container and is thus in contact with the liquid, such that the dip tube can form the element via which electrostatic charges of the liquid can be dissipated.

The dip tube is conductively connected to the outer layer, in particular by additional conductive connections, so that the electrostatic charges can be dissipated via the dip tube and the outer layer of the container.

This is necessary because the dip tube is typically mounted electrically insulated from the outer layer in the container opening of the container, in particular by interleaving of an electrically insulating seal.

According to an embodiment that is advantageous from a design perspective, the dip tube has a dip tube head mounted in the container opening. An opening of the dip tube head can be closed off with the closure means, whereby the container opening is closed off.

In this regard, the dip tube has a liquid channel running in the axial direction. The opening-out of the liquid channel on the top of the dip tube forms the opening that can be closed off using the closure means.

### BRIEF DESCRIPTION OF THE DRAWINGS

The invention is explained below on the basis of the drawings. They show:

FIG. 1: A schematic illustration of a dispensing system with a container.

FIG. 2: A partial illustration of the container according to FIG. 1 with a closure means that closes a container opening.

FIG. 3: A first example of a dip tube of the dispensing system according to FIG. 1 with an associated closure means.

FIG. 4: A second example of a dip tube of the dispensing system according to FIG. 1 with an associated closure means.

FIG. 5: A further exemplary embodiment of a container with a closure means.

### DETAILED DESCRIPTION OF THE PREFERRED EMBODIMENTS

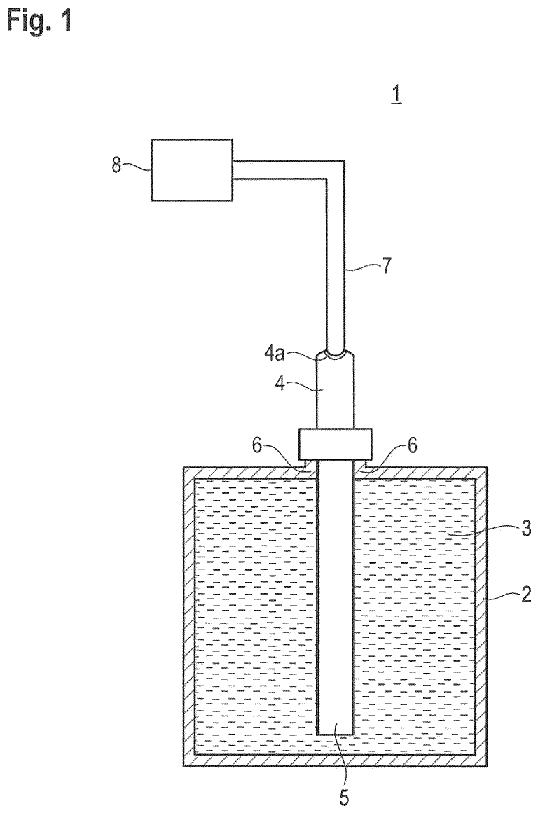

FIG. 1 shows schematically an exemplary embodiment of a dispensing system 1 for transportable containers 2, which in particular can be barrels or similar. A liquid 3 is stored in the respective container 2. The liquids 3 stored in such containers 2 are, in particular, special chemicals in liquid form that can be, in particular, highly flammable.

The dispensing system 1 comprises a dispense head 4, which can be fastened to a dip tube 5. The dip tube 5 is mounted in a container opening which is bordered by an edge segment 6 of the container 2. The longitudinal axis of the dip tube 5 runs in the vertical direction.

The dispense head 4 is used for dispensing liquids 3 from the container 2. Likewise, this can be used for filling containers 2. For this purpose, the dispense head 4 has a liquid connection 4a at its upper end. A line 7 that leads to a pump 8 is connected to this liquid connection 4a. The line 7 can be designed as a hose. The pump 8 is controlled by a control unit (not shown).

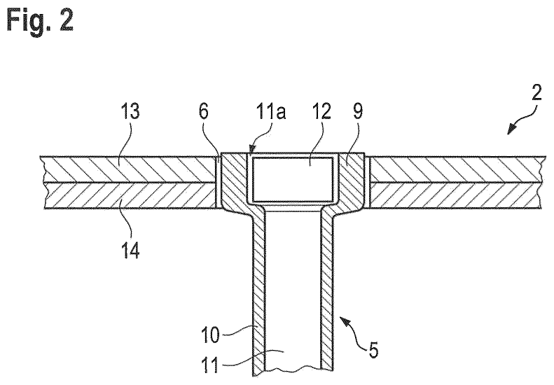

FIG. 2 shows a highly schematic detail illustration of the container 2 of the dispensing system 1 according to FIG. 1.

As can be seen from FIG. 2, the dip tube 5 has on its top a dip tube head 9. A tube segment 10 attaches to the bottom of the dip tube head 9, the cavity of which tube segment 10 forms a liquid channel. The dip tube 5 is designed essentially with rotational symmetry relative to its longitudinal axis.

As shown in FIG. 2, the dip tube head 9 is mounted in the container opening of the container 2, preferably by a screw connection. A seal (not shown) consisting of electrically insulating material can be present between the edge segment 6 bordering the container opening, and the dip tube head 9.

The longitudinal axis of the tube segment 10 of the thus mounted dip tube 5 runs in the vertical direction and extends into the interior of the container 2.

The liquid channel 11 opens out on the top of the dip tube head 9 and there forms an opening 11a, to which the dispense head 4 of the dispensing system 1 can be connected, for example by constituting a screw connection.

FIG. 2 shows the container 2 with the dispense head 4 removed. The opening 11a of the dip tube head 9 is then, as shown further in FIG. 2, closed off with a closure means 12 which in the present case is formed by a closure stopper.

The closure means 12 can be fixed in the opening 11a of the dip tube head 9 using a screw, latch or clamp connection, such that the closure means 12 tightly closes off the opening 11a, and thus also the container opening of the container 2.

To prevent electrostatic charges of the liquid 3 and a risk of explosion caused thereby, corresponding safety elements are provided.

For this purpose, the container 2 has a multilayer wall with an outer layer 13 consisting of dissipative material and an inner layer 14 consisting of an electrically insulating material. (FIG. 2)

In this context, the dissipative material is an electrically conductive plastic or a metallic material. The inner layer 14 consists of an electrically insulating plastic.

Furthermore, the dip tube 5 also consists of an electrically dissipative material.

Since the dip tube 5 is connected in an electrically insulated manner to the container 2 by the seal or respectively, the inner layer 14, a conductive connection is created between the dip tube 5 and the container 2 by additional electrically conductive elements. Thereby electrostatic charges of the liquid 3 can be dissipated via the dip tube 5 and the outer layer 13 of the container 2.

According to the invention, the closure means 12 also consists of electrically dissipative material and thus forms an additional safety element for dissipating electrostatic charges of the liquid 3.

Advantageously, the closure means 12 is conductively connected to the outer layer 13 of the container 2, wherein a conductive connection is created for this purpose via the dip tube 5.

The closure means 12 prevents electrostatic charges in particular when it is actuated with a grounded tool for opening or closing the opening 11a of the dip tube 5.

Advantageously, the closure means 12 and the dip tube 5 as well consist of an electrically insulating plastic with which electrically conductive particles are mixed, which are designed as soot or carbon particles, for example.

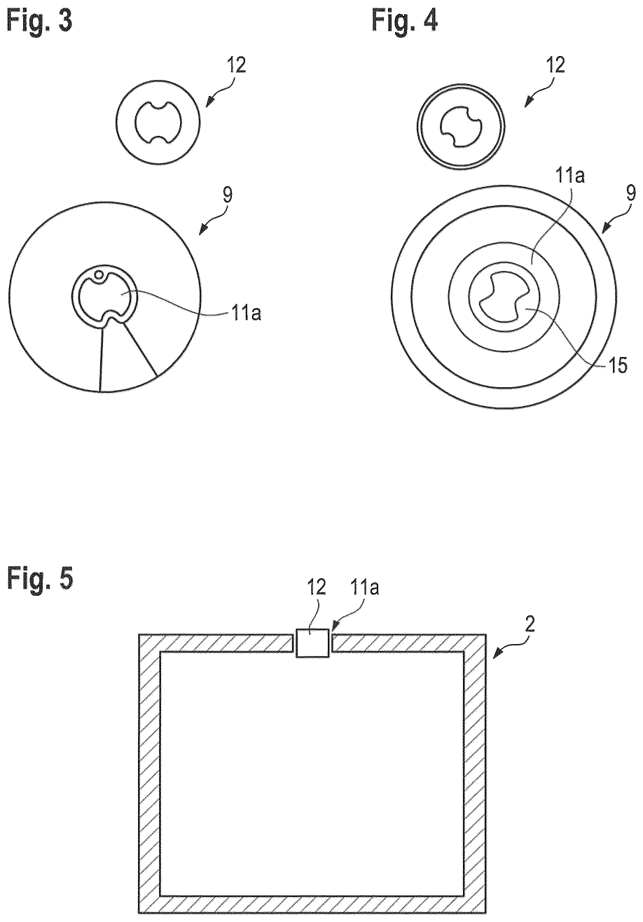

FIG. 3 shows a first embodiment of a dip tube 5 with associated closure means 12. In this context, FIG. 3 shows a top-down view onto the top of the dip tube closure having a central opening 11a, which can be closed off with the closure means 12. When the closure means 12 is seated, its edge lies on the edge of the dip tube closure bordering the opening 11a.

FIG. 4 shows a further embodiment of a dip tube 5 with associated closure means 12. In this case, a tubular lip 15 is located in the region of the opening 11a of the tip tube head 9, onto which lip 15 the closure means 12 can be seated.

FIG. 5 shows an exemplary embodiment of a container 2 without dip tube 5. Again, the container 2 has a multilayer wall with an outer layer 13 consisting of electrically dissipative material and an inner layer 14 consisting of electrically insulating material.

In this case, the closure means 12 is directly inserted into the container opening of the container 2.

Corresponding to the embodiment from FIGS. 1 and 2, in this case as well the closure means 12 made of electrically dissipative material reduces the danger of electrostatic charges in the liquid 3 stored in the container 2.

### List of Reference Numerals

(1) Dispensing system
(2) Container
(3) Liquid
(4) Dispense head
(4a) Liquid connection
(5) Dip tube
(6) Edge segment
(7) Line
(8) Pump
(9) Dip tube head
(10) Tube segment
(11) Liquid channel
(11a) Opening
(12) Closure means
(13) External layer
(14) Internal layer
(15) Tubular lip

1. A container (2) for storing a liquid (3), with a container opening and with a closure means (12) designed for closing the container opening, characterized in that the closure means (12) is designed for dissipating electrostatic charges of the liquid (3) in that it is made of electrically dissipative material.

2. The container (2) according to claim 1, characterized in that the closure means (12) is a closure stopper.

3. The container (2) according to claim 1, characterized in that the closure means (12) is designed such that it can be opened with a grounded tool.

4. The container (2) according to claim 1, characterized in that the closure means (12) consists of plastic containing electrically conductive particles.

5. The container (2) according to claim 4, characterized in that the conductive particles are soot or carbon particles.

6. The container (2) according to claim 1, characterized in that it has an outer layer (13) consisting of electrically dissipative material and an inner layer (14) consisting of electrically insulating material.

7. The container (2) according to claim 6, characterized in that the closure means (12) is electrically conductively connected to the outer layer (13).

8. The container (2) according to claim 6, characterized in that an element made of electrically conductive or electrically dissipative material is present, which is connected electrically conductively to the outer layer (13) consisting of electrically dissipative material which protrudes into the container (2) and can be brought into contact with the liquid (3).

9. The container (2) according to claim 1, characterized in that it has a dip tube (5) consisting of electrically dissipative material.

10. The container (2) according to claim 8, characterized in that the dip tube (5) is the element.

11. The container (2) according to claim 9, characterized in that the dip tube (5) has a dip tube head (9) mounted in the container opening and in that an opening (11a) of the dip tube head (9) can be closed off using the closure means (12), whereby the container opening is closed off.

12. The container (2) according to claim 11, characterized in that the dip tube (5) has a liquid channel (11) running in the axial direction, wherein the opening out of the liquid channel (11) on the top of the dip tube (5) forms the opening (11a) that can be closed off using the closure means (12).

13. A dispensing system (1) with at least one container (2) according to claim 1, characterized in that a dispense head (4) is present that is designed for filling the container (2) with liquid (3) and/or for dispensing liquid (3) from the container (2).

14. The dispensing system (1) according to claim 13, characterized in that the dispense head (4) can be connected to the container opening while the closure means (12) is released.

15. The dispensing system (1) according to claim 9, characterized in that the dispense head (4) can be connected to the dip tube (5) while the closure means (12) is released.
